(19) United States
(12) Patent Application Publication
(10) Pub. No.: US 2016/0332168 A1
(43) Pub. Date: Nov. 17, 2016

(54) MATERIAL SEPARATION AND TRANSFER CONVEYOR

(71) Applicant: Astec Industries, Inc., Chattanooga, TN (US)

(72) Inventors: Arnold Neil Peterson, Eugene, OR (US); Bradly Michael Deuerling, Eugene, OR (US); Adam James Love, Eugene, OR (US); Jason Duke Tift, Cheshire, OR (US)

(73) Assignee: Astec Industries, Inc., Chattanooga, TN (US)

(21) Appl. No.: 15/151,943

(22) Filed: May 11, 2016

Related U.S. Application Data
(60) Provisional application No. 62/160,132, filed on May 12, 2015.

(51) Int. Cl. B03C 1/30; B03C 1/26; B03C 1/20

(52) U.S. Cl. CPC B03C 1/30; B03C 1/20; B03C 1/26

(57) ABSTRACT

A sorting conveyor for separating ferromagnetic materials from a stream of materials includes a conveyor component having an input end and an output end. The sorting conveyor also includes a conveyor drive system for driving the conveyor component to move the stream of materials from the input end to the output end for discharge of at least a portion of the stream of materials as a product stream at the output end. A magnetic separator is located adjacent the conveyor component and adapted to divert ferromagnetic materials from the stream of materials into a metal stream that is separate from the product stream.

### CROSS-REFERENCE TO RELATED APPLICATION

This application claims the benefit of U.S. Provisional Patent Application No. 62/160,132, which was filed on May 12, 2015.

### FIELD OF THE INVENTION

The present invention relates generally to machines for use in processing various materials, especially those obtained in a structural demolition process, so that such materials can be safely and efficiently reduced in a material reduction machine. More particularly, this invention relates to a conveyor for transferring materials to be reduced that may include easily reducible components such as wood, and irreducible components such as ferromagnetic materials.

### BACKGROUND OF THE INVENTION

Material reducing machines are well-known for use in connection with the demolition of a house or other structure. Such machines typically include a conveyor for moving debris such as wood, siding, roofing materials and even appliances such as water heaters toward a rotating drum having tools thereon which is contained within a housing having an anvil bar located in close proximity to the free ends of the rotating drum tools. The tools of the rotating drum carry material into contact with the anvil bar where it is broken into smaller pieces. Most commonly, a plurality of screen sections are located adjacent to and downstream of the anvil bar so that further rotation of the drum causes partially reduced material to be further reduced by successive impacts of the tools of the rotating drum until it will pass through the apertures in one or another of the screens.

Known material-reducing machines may not be suitable for use in reducing all types of materials, particularly if there is the possibility that an object which cannot be reduced, such as a large metal component or fragment, or an item that contains metal such as a railroad tie which includes metal tie plates and spikes, can be introduced into the machine. Some machines include shear pins that will break when an object that cannot be reduced is introduced, thereby allowing a portion of the machine housing to pivot or otherwise move so as to enlarge the opening through which the object can pass. In machines which include a shear pin, operator intervention is required when a pin shears in order to get the machine back into operating order.

It would be advantageous if a sorting conveyor could be provided that would reliably remove ferromagnetic materials from the material stream being processed before the material in the material stream reaches the reducing drum of an associated material reducing machine.

### Notes on Construction

The use of the terms “a”, “an”, “the” and similar terms in the context of describing the invention are to be construed to cover both the singular and the plural, unless otherwise indicated herein or clearly contradicted by context. The terms “comprising”, “having”, “including” and “containing” are to be construed as open-ended terms (i.e., meaning “including, but not limited to,”) unless otherwise noted. The terms “substantially”, “generally” and other words of degree are relative modifiers intended to indicate permissible variation from the characteristic so modified. The use of such terms in describing a physical or functional characteristic of the invention is not intended to limit such characteristic to the absolute value which the term modifies, but rather to provide an approximation of the value of such physical or functional characteristic. All methods described herein can be performed in any suitable order unless otherwise specified herein or clearly indicated by context.

The use of any and all examples or exemplary language (e.g., “such as” and “preferably”) herein is intended merely to better illuminate the invention and the preferred embodiments thereof, and not to place a limitation on the scope of the invention. Nothing in the specification should be construed as indicating any element as essential to the practice of the invention unless so stated with specificity.

Various terms are specifically defined herein. These terms are to be given their broadest possible construction consistent with such definitions, as follows:

The term “material reducing machine” refers to a machine that is adapted to cut, chop, shred, break or otherwise reduce material into smaller pieces.

The term “material stream” refers to a collection of materials that is moved on or by a sorting conveyor.

The terms “upper”, “top” and similar terms, when used in reference to a relative position or direction on or with respect to a sorting conveyor, or a component or portion of such a conveyor, refer to a relative position or direction that is farther away from the surface on which the sorting conveyor or component thereof is placed for operation.

The terms “lower”, “bottom” and similar terms, when used in reference to a relative position or direction on or with respect to a sorting conveyor, or a component or portion of such a conveyor, refer to a relative position or direction that is nearer the surface on which the sorting conveyor or component thereof is placed for operation.

The term “front end” and similar terms refer to the end of a sorting conveyor, or a component or portion of such a conveyor, which is nearest the point at which material is introduced onto the sorting conveyor.

The terms forward”, “in front of”, and similar terms, as used herein to describe a relative position or direction on or in connection with a sorting conveyor, or a component or portion of such a conveyor, refer to a relative position or direction towards the front end of the sorting conveyor.

The terms “back end”, “rear end” and similar terms refer to the end of a sorting conveyor, or a component or portion of such a conveyor, which is farther from the front end of the conveyor, component or portion thereof.

The terms “rearward”, “behind”, and similar terms, as used herein to describe a relative position or direction on or in connection with a sorting conveyor or a component or portion of such a conveyor, refer to a relative position or direction towards the rear end of the sorting conveyor.

The term “downstream”, as used herein to describe a relative position on or in connection with a sorting conveyor, refers to a relative position in the direction of movement of the material stream, i.e., from the front end of the sorting conveyor towards the back end.

The term “upstream”, as used herein to describe a relative position on or in connection with a sorting conveyor, refers to a relative position in a direction that is opposite to the direction of movement of the material stream.

The term “linear actuator” refers to an actuator that generates force which is directed in a straight line. Common examples of “linear actuators” include double-acting hydraulic or pneumatic actuators which include a cylinder, a piston within the cylinder, and a rod attached to the piston. By increasing the pressure within the cylinder on one side of the piston (over that on the opposite side of the piston), the rod will extend from the cylinder or retract into the cylinder.

### SUMMARY OF THE INVENTION

The invention comprises a sorting conveyor for separating ferromagnetic materials from a stream of materials. This sorting conveyor has a conveyor component with an input end and an output end. Means are provided for driving the conveyor component to move the stream of materials from the input end to the output end for discharge of at least a portion of the stream of materials as a product stream at the output end. The sorting conveyor also includes a magnetic separator that is located adjacent the conveyor component and adapted to divert ferromagnetic materials from the stream of materials into a metal stream that is separate from the product stream.

In one embodiment of the invention, the magnetic separator comprises a magnetic drum separator that is located below and adjacent to the output end of the conveyor component so that material falling off the output end of the conveyor component passes across the magnetic drum separator and is diverted from the product stream. In another embodiment of the invention, the magnetic separator comprises a magnetic belt separator that is mounted below the conveyor component near its output end and includes a belt that is driven in a direction that is generally transverse to the direction of the stream of materials on the conveyor component.

In order to facilitate an understanding of the invention, the preferred embodiments of the invention are illustrated in the drawings, and a detailed description thereof follows. It is not intended, however, that the invention be limited to the particular embodiments described or to use in connection with the apparatus illustrated herein. Various modifications and alternative embodiments such as would ordinarily occur to one skilled in the art to which the invention relates are also contemplated and included within the scope of the invention described and claimed herein.

### Advantages of Preferred Embodiments of the Invention

Among the advantages of the invention is that it provides a sorting conveyor that reliably removes ferromagnetic materials from the material stream being processed and diverts such ferromagnetic materials from the stream of materials into a metal stream that is separate from the product stream. Other advantages and features of this invention will become apparent from an examination of the drawings and the ensuing description.

### BRIEF DESCRIPTION OF THE DRAWINGS

The presently preferred embodiments of the invention are illustrated in the accompanying drawing drawings, in which:

FIG. 1 is a side view of a material reducing machine and a sorting conveyor that is configured according to a first embodiment of the invention.

FIG. 2 is a side view of the sorting conveyor shown in FIG. 1.

FIG. 3 is a front perspective view of the sorting conveyor shown in FIGS. 1 and 2, and a portion of the input conveyor of the material reducing machine that is shown in FIG. 1.

FIG. 4 is a rear perspective view of the sorting conveyor shown in FIGS. 1-3, and a portion of the input conveyor of the material reducing machine that is shown in FIGS. 1 and 3.

FIG. 5 is a schematic side view of the sorting conveyor shown in FIGS. 1-4 and a portion of the input conveyor of the material reducing machine that is shown in FIGS. 1, 3 and 4, which illustrates the operation of the first embodiment of the sorting conveyor in connection with a material reducing machine.

FIG. 6 is a side view of a portion of an input conveyor for a material reducing machine such as is shown in FIG. 1, and a sorting conveyor that is configured according to a second embodiment of the invention that is shown in the operating orientation.

FIG. 7 is a side view of the sorting conveyor shown in FIG. 6 in a lowered orientation.

FIG. 8 is a front perspective view of the sorting conveyor shown in FIGS. 6 and 7 with a portion of the input conveyor of the material reducing machine that is shown in FIG. 6.

FIG. 9 is a schematic side view of a third embodiment of a sorting conveyor that is very similar to the second embodiment shown in FIGS. 6-8, and a portion of the input conveyor of the material reducing machine that is shown in FIGS. 6 and 8, which illustrates the operation of the third embodiment of the sorting conveyor.

### DESCRIPTION OF THE PREFERRED EMBODIMENTS OF THE INVENTION

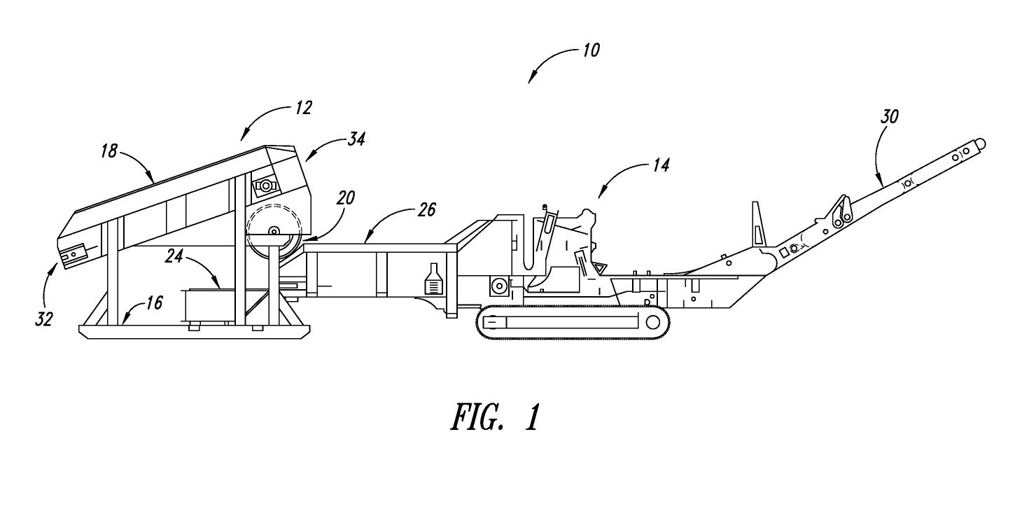

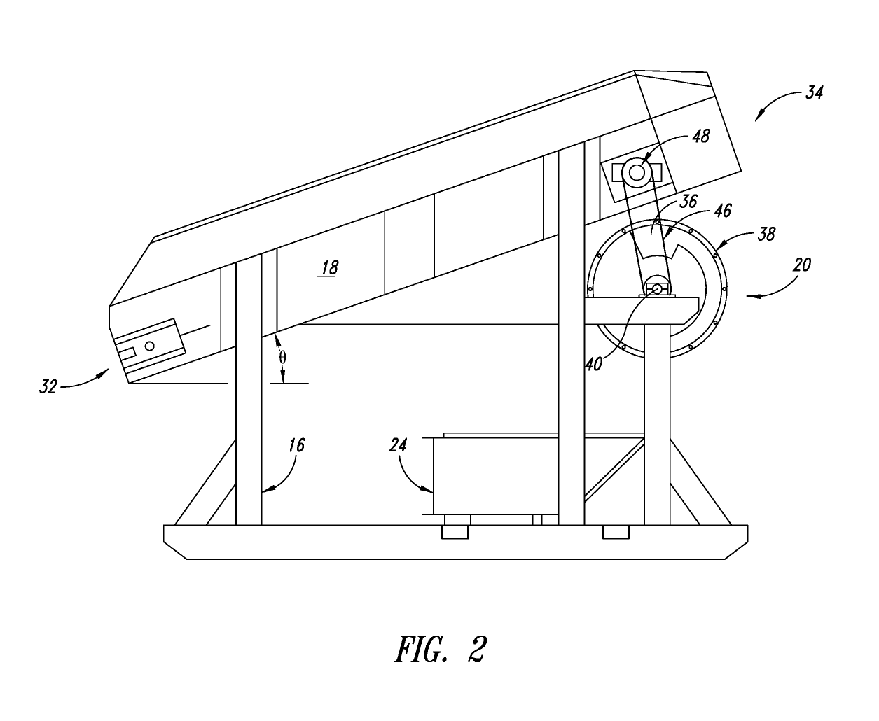

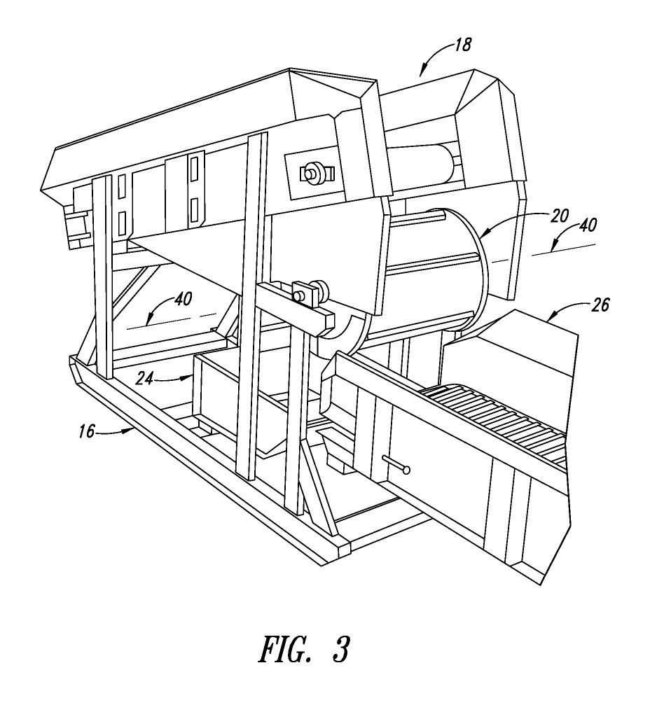

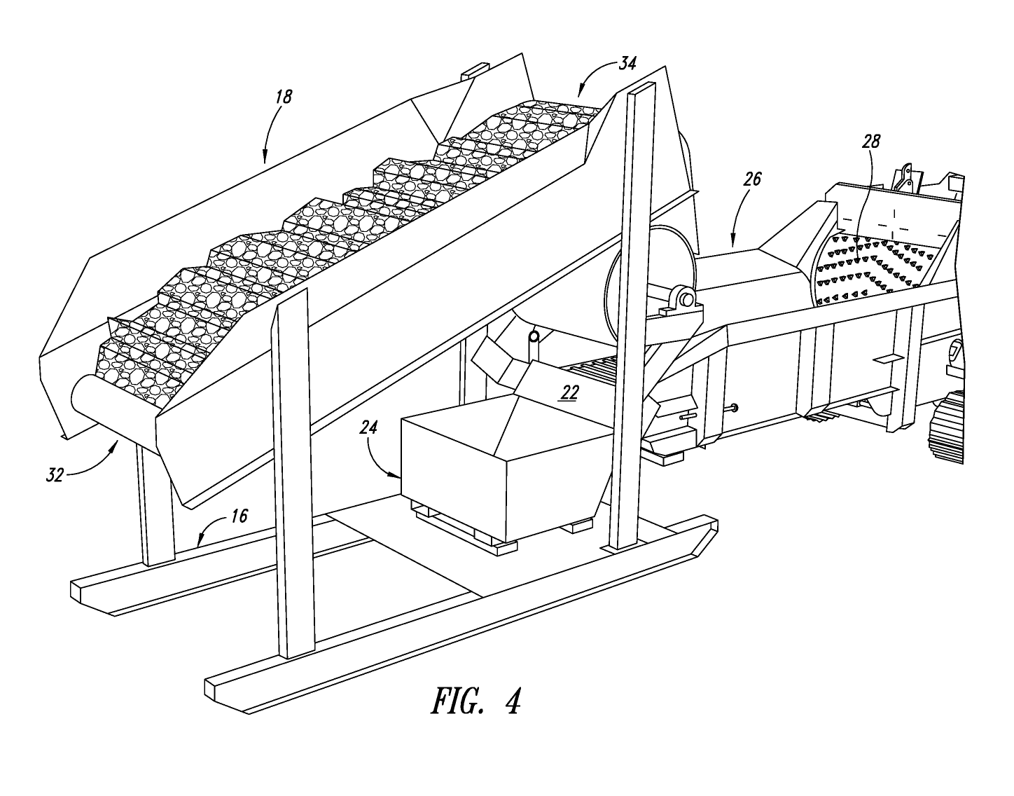

A first embodiment of the invention is illustrated in FIGS. 1-5. As shown therein, material reducing system 10 includes two primary components, sorting conveyor 12 and material reducing machine 14. Sorting conveyor 12 includes skid frame 16, inclined conveyor component 18, magnetic drum separator 20 and separator slide 22 (shown in FIG. 4) for directing separated ferromagnetic materials into collection bin 24. In other embodiments of the invention, an eddy current separator (not shown) may be employed to separate non-ferromagnetic metals from the material stream, and/or conveyor component 18 may be in a generally horizontal orientation.

Conventional material reducing machine 14 includes a generally horizontal material input device such as input conveyor 26. Input conveyor 26 is adapted to move material to be reduced toward reducing drum 28 (best shown in FIG. 4). In other embodiments of the invention, the material input device for the material reducing machine may comprise a chute, and it may be placed with respect to the reducing drum other than in a generally horizontal orientation. Material that is reduced by reducing drum 28 is conveyed off the rear end of machine 14 by discharge conveyor 30.

Sorting conveyor 12 is located in front of material reducing machine 14 or it may be used in a stand-alone manner. In either event, sorting conveyor is adapted to separate ferromagnetic materials from a material stream. Inclined conveyor component 18 of sorting conveyor 12 is preferably a slat-type conveyor that is inclined at angle θ with respect to the horizontal. Preferably, angle θ is within the range of about 10° to about 45°, most preferably about 20°. Inclined conveyor component 18 has front input end 32 and rear output end 34. In this embodiment of the invention, a conventional conveyor drive system (not shown) comprising a generator set for generating electric power or an internal combustion engine, one or more hydraulic motors and associated hydraulic circuitry including a hydraulic pump or one or more electric motors, or other known drive means is provided to drive conveyor component 18 to move the stream of materials from input end 32 to output end 34 for discharge of at least a portion of the stream of materials as a product stream at the output end. Preferably, the drive system is adapted to drive conveyor component 18 at a plurality of rates.

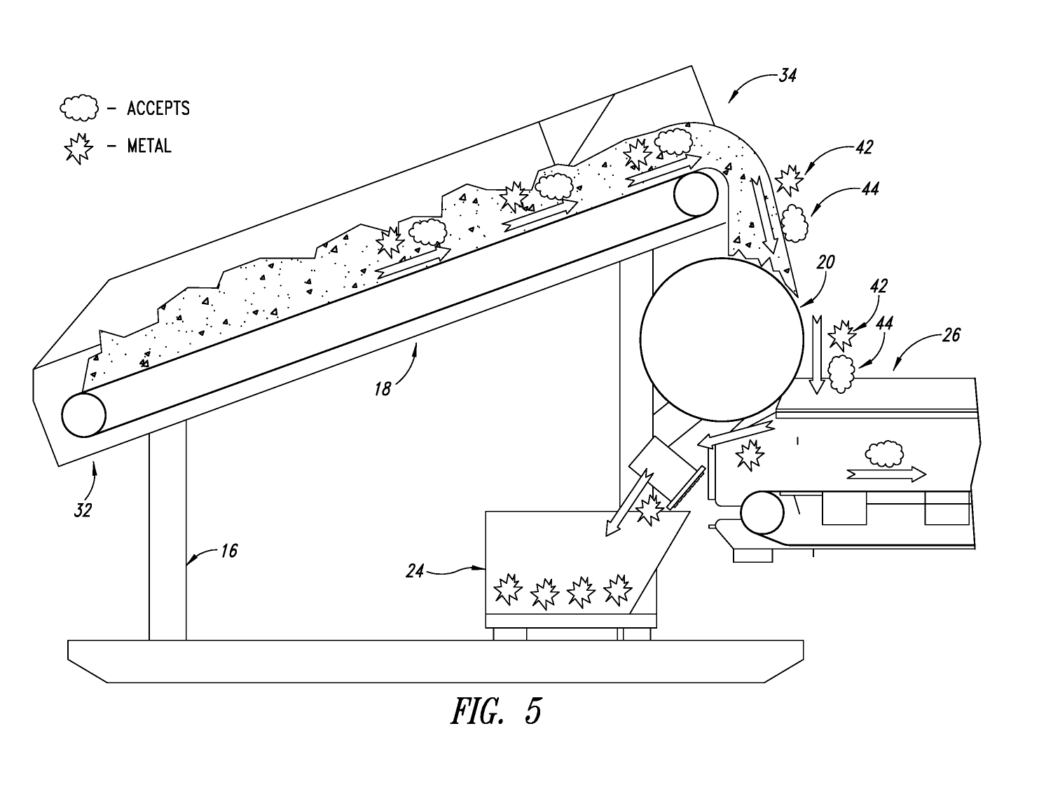

Sorting conveyor 12 includes a magnetic separator that is located adjacent conveyor component 18 and adapted to divert ferromagnetic materials from the stream of materials into a metal stream that is separate from the product stream. In the embodiment of the invention shown in FIGS. 1-5, the magnetic separator comprises magnetic drum separator 20, which is located below and adjacent to output end 34 of inclined conveyor component 18 so that material falling off output end 34 of the sorting conveyor passes across the exterior of magnetic drum separator 20, as shown in FIG. 5. Preferably, magnetic drum separator 20 is a Model MDS4848CDA079 magnetic drum separator made and sold by Industrial Magnetics, Inc. of Boyne City, Mich. This magnetic drum separator has a stationary magnet 36 within outer drum 38, which outer drum rotates about generally horizontal drum axis 40.

Material reducing machine 14 is located downstream of sorting conveyor 12 and situated so that the product stream of material falling off output end 34 of inclined conveyor component 18 can fall onto input conveyor 26 of the material reducing machine. However, because of the placement of magnetic drum separator 20 with respect to the material reducing machine, a metal stream comprising ferromagnetic materials 42 in the material stream is separated from the non-ferromagnetic product stream 44 of the material stream and diverted away from input conveyor 26 of the material reducing machine, as shown in FIG. 5. Separator slide 22 (shown in FIG. 4) assists in directing separated ferromagnetic materials 42 into collection bin 24.

In the embodiment of the invention illustrated in FIGS. 1-5, inclined conveyor component 18 is driven in series with input conveyor 26 of the material reducing machine as controlled by a controller (not shown). Furthermore, the rotating drum 38 of magnetic drum separator 20 is preferably driven by a chain or belt drive 46 from output end conveyor shaft 48 of inclined conveyor component 18. Consequently, input conveyor 26, inclined conveyor component 18 and drum 38 of magnetic drum separator 20 may all be tied together with a series-type drive system, so that when input conveyor 26 is started, inclined conveyor component 18 and drum 38 of magnetic drum separator 20 will also operate.

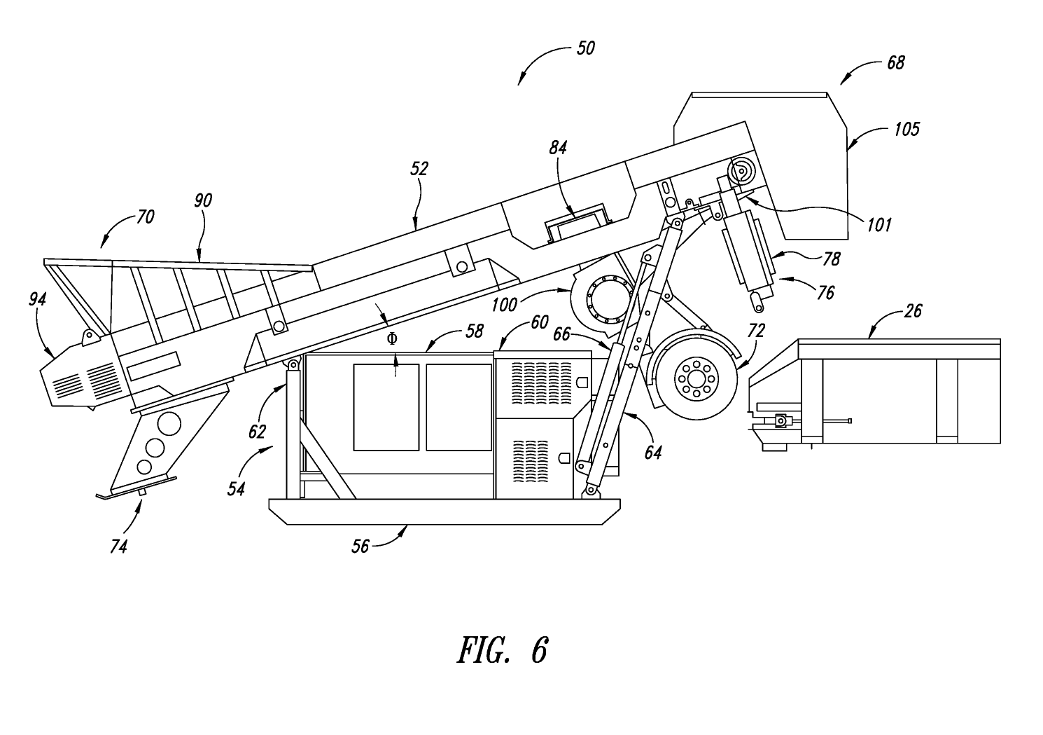

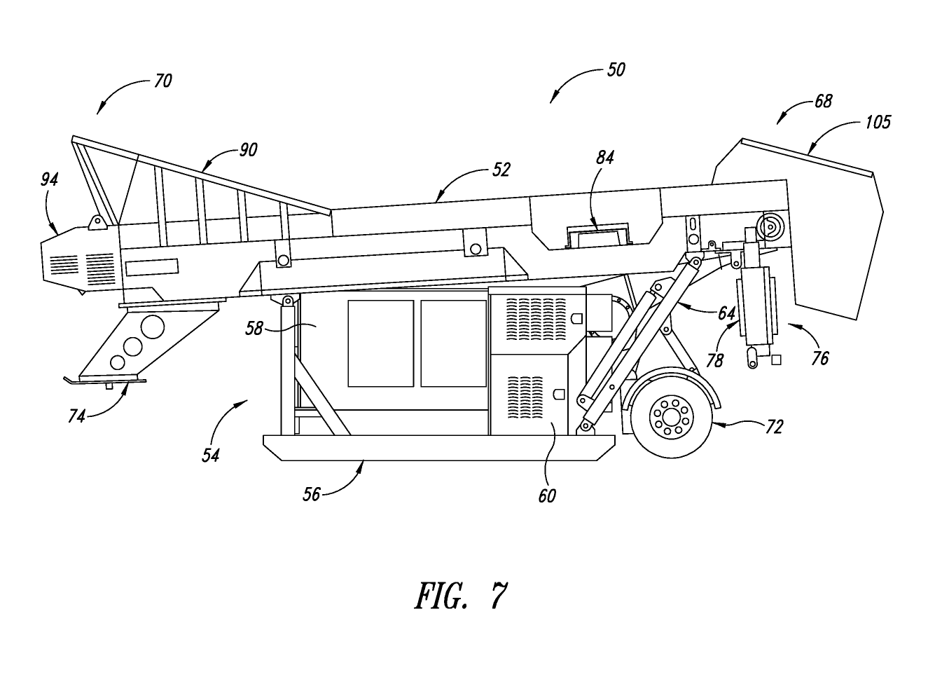

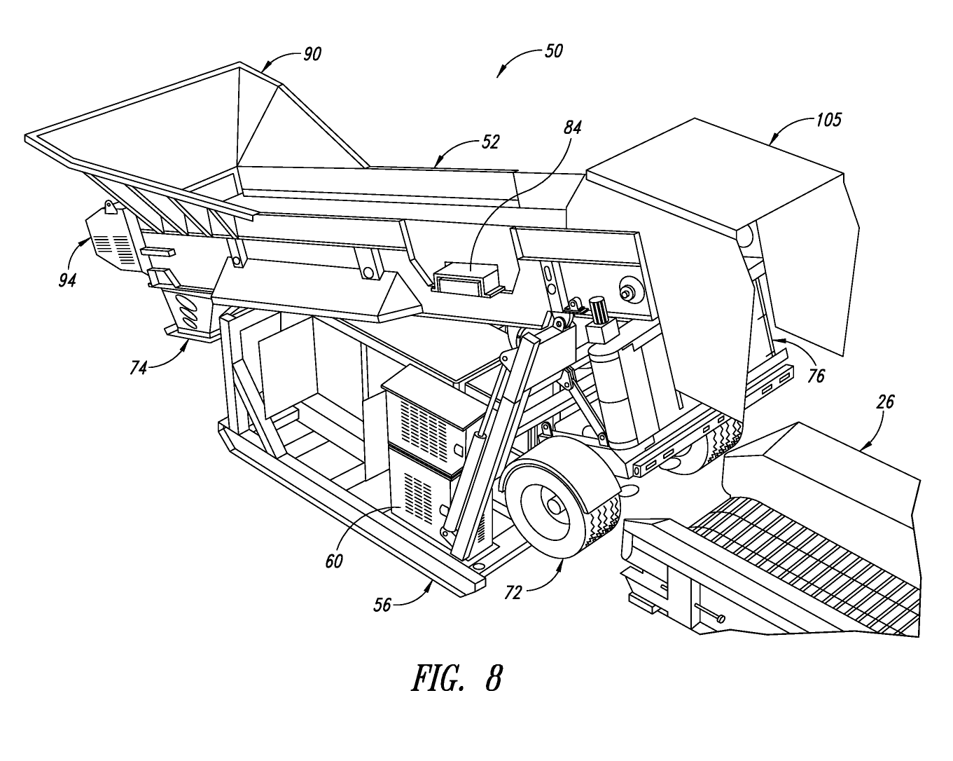

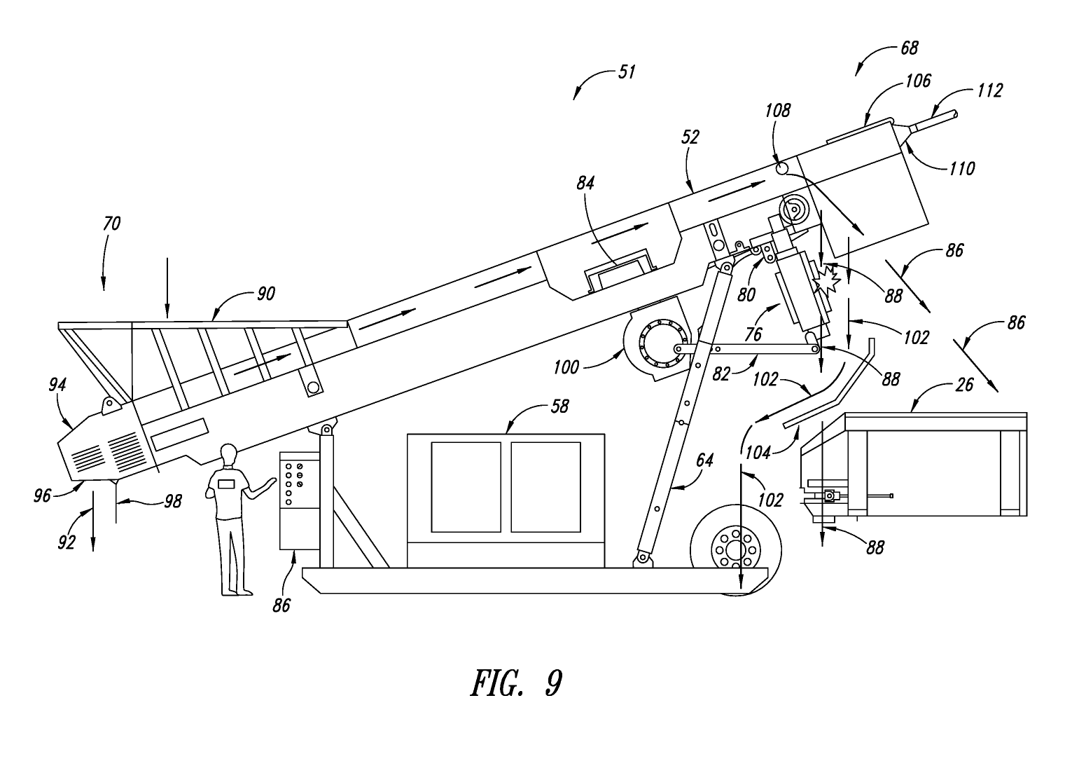

A second embodiment of the invention is illustrated in FIGS. 6-8 and a third embodiment, which is very similar to the second embodiment, is illustrated in FIG. 9. Sorting conveyor 50 (FIGS. 6-8) or sorting conveyor 51 (FIG. 9) is provided for separating ferromagnetic materials from a stream of materials. These sorting conveyors may be used in conjunction with a material reducing machine such as machine 14 shown in FIG. 1, or they may be used in a stand-alone manner. As shown in FIG. 6, sorting conveyor 50 is located upstream of input conveyor 26 of the material reducing machine. Sorting conveyor 50 and sorting conveyor 51 include conveyor component 52 that is attached to frame 54. Frame 54 includes skid 56 on which is mounted a power supply for the conveyor drive system and other operating systems, preferably a 30 kW generator set 58, and a controller which is located in cabinet 60. Conveyor component 52 is pivotally attached to frame 54 by means of a plurality of struts including fixed-length strut 62 and variable-length strut 64. Linear actuator 66 (not shown in FIG. 9) is attached to variable-length strut 64 and adapted to be extended from the lowered position shown in FIG. 7 to the extended position shown in FIG. 6, thereby raising output end 68 of conveyor component 52 with respect to input end 70 so that conveyor component 52 is inclined with respect to the horizontal at an adjustable angle Φ, which is preferably within the range of about 10° to about 45°, most preferably about 20°. Conveyor component 52 also includes wheel set 72 and tractor hitch 74 so that it may be placed in a lowered travel configuration and transported by highway to a job site.

Sorting conveyor 50 and sorting conveyor 51 include conventional conveyor drive systems comprising one or more hydraulic motors and associated hydraulic circuitry including a hydraulic pump or one or more electric motors, or other known drive means for driving conveyor component 52 to move a stream of materials from input end 70 to output end 68 for discharge of at least a portion of the stream of materials as a product stream at the output end. Preferably, the conveyor drive systems for these sorting conveyors are adapted to drive conveyor component 52 at a plurality of rates.

Sorting conveyors 50 and 51 also include a magnetic separator comprising magnetic belt separator 76 that is located adjacent to the conveyor component and adapted to divert ferromagnetic materials from the stream of materials into a metal stream that is separate from the product stream. Magnetic belt separator 76 is preferably an SMS (Suspended Magnetic Separator) made and sold by Industrial Magnetics, Inc. of Boyne City, Mich. Magnetic belt separator 76 has a belt 78 that is driven in a direction that is generally transverse to the direction of the stream of materials on the conveyor component (i.e., perpendicular to the plane of the page of FIGS. 6, 7 and 9). Preferably, as shown in FIG. 9, magnetic belt separator 76 is pivotally mounted to bracket 80 on the underside of conveyor component 52 and to bracket 82, which is adjustably and pivotally mounted to variable-length strut 64 so that belt 78 can be placed in a plurality of positions with respect to output end 68 of conveyor component 52.

It is also preferred that sorting conveyors 50 and 51 include ferromagnetic material detector 84 for detecting the presence of ferromagnetic materials in the stream of materials on the conveyor component. Ferromagnetic material detector 84 is preferably an MP-2000 Series digital under-conveyor metal detector system made and sold by Metal Detectors, Inc. of Eugene, Oreg. As best shown in FIG. 9, ferromagnetic material detector 84 is located upstream of the magnetic separator and on the lower side of conveyor component 52. This embodiment of the invention includes a controller and a timer, both of which are located in cabinet 60 in the configuration of FIGS. 6-8 or in cabinet 86 in the configuration of FIG. 9. The controller is operatively connected to the timer, to the conveyor drive system for driving the conveyor component and to ferromagnetic material detector 84. The ferromagnetic material detector is adapted to send a detection signal to the controller when it detects the presence of ferromagnetic materials on conveyor component 52, and to stop sending the detection signal when it no longer detects the presence of ferromagnetic materials on conveyor component 52. The controller is programmed to drive conveyor component 52 at a predetermined first rate until ferromagnetic material detector 84 detects the presence of ferromagnetic materials in the stream of materials on the conveyor component. Then, upon detection of ferromagnetic materials in the stream of materials on conveyor component 52, ferromagnetic material detector 84 will send a detection signal to the controller. Upon receipt of such detection signal, the controller will drive the conveyor component at a predetermined second rate that is slower than the first rate for a predetermined period of time in order to increase the efficiency of the magnetic belt separator. Thus, for example, the controller will drive the conveyor component at first rate within the range of 50-150 feet per minute, preferably about 100 feet per minute, until ferromagnetic material detector 84 detects the presence of ferromagnetic materials in the material stream on conveyor component 52. Then, the ferromagnetic material detector will send a detection signal to the controller and the controller will reduce the speed of conveyor component 52 to a second rate that is within the range of 10-40% of the predetermined first rate, or within the range of 5-60 feet per minute, preferably about 20 feet per minute. The controller will cause the conveyor component to be driven at the slower rate for a predetermined period of time, such as for example 15-40 seconds, preferably about 25 seconds, and after this period has elapsed, the controller will then drive the conveyor component at the predetermined first rate. If, during the predetermined period of time the conveyor component is driven at the slower rate, the ferromagnetic material detector senses the presence of additional ferromagnetic materials in the material stream, the controller may be programmed to reset the timer to continue operation of the conveyor component at the slower rate in order to allow for efficient removal of the additional ferromagnetic materials by the magnetic belt separator. When ferromagnetic materials fall off output end 68 of conveyor component 52, magnetic belt separator 76 will draw such materials towards belt 78 so that the belt may carry such materials in a transverse direction to that of the material stream, as indicated by arrows 88 in FIG. 9.

Sorting conveyors 50 and 51 are particularly useful in processing a material stream including materials having varying densities, such as a mixture of wood, ferromagnetic materials, relatively dense materials such as rocks and bricks and relatively light materials such as drywall, paper and plastics. Such a mixture of materials is commonly obtained from the demolition of a house or other structure. Thus, as shown in FIGS. 6, 8 and 9, sorting conveyors 50 and 51 include feed hopper 90 at input end 70. As described above, conveyor component 52 is adapted to be inclined with respect to the horizontal at an adjustable angle Φ with output end 68 being higher than input end 70 so that materials of a predetermined input density, such as rocks and bricks, that are placed into the feed hopper will fall off the input end of the conveyor component, as indicated by arrow 92 in FIG. 9, before being carried to the output end. Preferably, sorting conveyor 50 and sorting conveyor 51 include an input end enclosure 94 for input end 70 of conveyor component. This input end enclosure has a lower side with an opening 96 therein through which materials of a predetermined input density will pass as such materials fall off the input end of conveyor component 52. Hinged door 98 is provided to close off opening 96, if desired.

Sorting conveyor 50 and sorting conveyor 51 include blower 100 that is mounted onto the bottom of conveyor component 52 and adapted to direct a stream of air through blower nozzle 101 into the material falling off output end 68 to direct material of a predetermined product density (such as that of woody materials) into a product stream that follows a path indicated by arrows 86 (shown in FIG. 9). Materials in the material stream that have a density greater than that of the predetermined product density and are not separated from the product stream by the magnetic separator will fall off output end 68 of conveyor component in a path indicated by arrows 102 (shown in FIG. 9). A deflector 104 may be provided to insure that such high-density, non-ferromagnetic materials do not fall into input conveyor 26 of the material reducing machine.

In the embodiments of the invention shown in FIGS. 6-9, output end 68 of conveyor component 52 is partially enclosed by an output end enclosure such as enclosure 105 shown in FIGS. 6-8 or enclosure 106 shown in FIG. 9. Sorting conveyor 50 and sorting conveyor 51 may also include one or more spray assemblies, such spray nozzle 108 (shown in FIG. 9) for spraying a dust suppression fluid such as water into or within the output end enclosure. In the embodiment of the invention shown in FIG. 9, vacuum hood 110 is attached to output end enclosure 106.

This vacuum hood supports a vacuum fan that is adapted to create a partial vacuum within the output end enclosure. Vacuum hood 110 also includes discharge outlet 112 through which low density materials such as dust may be discharged, by action of the vacuum fan, and thereby separated from the product stream.

Although this description contains many specifics, these should not be construed as limiting the scope of the invention but as merely providing illustrations of the presently preferred embodiments thereof, as well as the best mode contemplated by the inventors of carrying out the invention. The invention, as described herein, is susceptible to various modifications and adaptations, as would be understood by those having ordinary skill in the art to which the invention relates.

What is claimed is:

1. A sorting conveyor for separating ferromagnetic materials from a stream of materials, said sorting conveyor comprising:
(a) a conveyor component having an input end and an output end;
(b) a conveyor drive system for driving the conveyor component to move the stream of materials from the input end to the output end for discharge of at least a portion of the stream of materials as a product stream at the output end;
(c) a magnetic separator that is:
(1) located adjacent the conveyor component;
(2) adapted to divert ferromagnetic materials from the stream of materials into a metal stream that is separate from the product stream.

2. The sorting conveyor of claim 1 which includes a blower that is adapted to direct material of a predetermined product density into the product stream.

3. The sorting conveyor of claim 1 wherein the conveyor component is adapted to be driven in series with the input conveyor of an associated material reducing machine.

4. The sorting conveyor of claim 1 wherein the magnetic separator comprises a magnetic drum separator that is mounted below the conveyor component near its output end.

5. The sorting conveyor of claim 4 wherein the magnetic drum separator comprises:
(a) a drum that rotates about a generally horizontal drum axis;
(b) a stationary magnet located within the drum.

6. The sorting conveyor of claim 5 wherein the drum of the magnetic drum separator is driven by a chain or belt drive from the conveyor component.

7. The sorting conveyor of claim 1:
(a) which includes a feed hopper at the input end;
(b) wherein the conveyor component is adapted to be adjustably inclined with respect to the horizontal with the output end being higher than the input end so that materials of a predetermined input density that are placed into the feed hopper will fall off the input end of the conveyor component before being carried to the output end.

8. The sorting conveyor of claim 7 which includes an input end enclosure for the input end of the conveyor component, said input end enclosure having a lower side with an opening therein through which materials of a predetermined input density will pass as such materials fall off the input end of the conveyor component.

9. The sorting conveyor of claim 1 which includes:
(a) a ferromagnetic material detector for detecting the presence of ferromagnetic materials in the stream of materials on the conveyor component, said ferromagnetic material detector being located upstream of the magnetic separator;
(b) a timer;
(c) a controller that is operatively connected to the conveyor drive system, the ferromagnetic material detector and the timer, said controller being adapted to drive the conveyor component at a predetermined first rate until the ferromagnetic material detector detects the presence of ferromagnetic materials in the stream of materials on the conveyor component, and to drive the conveyor component at a predetermined second rate that is slower than the first rate for a predetermined period of time after the ferromagnetic material detector detects the presence of ferromagnetic materials in the stream of materials on the conveyor component.

10. The sorting conveyor of claim 9 wherein the controller is adapted to drive the conveyor component at the predetermined first rate after the conveyor component has been driven at the predetermined second rate for the predetermined period of time.

11. The sorting conveyor of claim 9 wherein the predetermined second rate is within the range of 10-40% of the predetermined first rate.

12. The sorting conveyor of claim 9 wherein:
(a) the predetermined first rate is within the range of 50-150 feet per minute;
(b) the predetermined second rate is within the range of 5-60 feet per minute;
(c) the predetermined period of time is within the range of 15-40 seconds.

13. The sorting conveyor of claim 1 wherein the magnetic separator comprises a magnetic belt separator that is mounted below the conveyor component near its output end.

14. The sorting conveyor of claim 13 wherein:
(a) the conveyor component is mounted to a conveyor frame;
(b) the magnetic belt separator has a belt that is driven in a direction that is generally transverse to the direction of the stream of materials on the conveyor component;
(c) the magnetic belt separator is adjustably mounted between the conveyor frame and the conveyor component so that the belt of the magnetic belt separator can be positioned in a plurality of positions with respect to the output end of the conveyor component.

15. The sorting conveyor of claim 1:
(a) wherein the output end of the conveyor component is partially enclosed by an output end enclosure;
(b) which includes a spray assembly for spraying a dust suppression fluid into or within the output end enclosure.

16. The sorting conveyor of claim 15 which includes a vacuum hood that is attached to the output end enclosure, said vacuum hood having a vacuum fan that is adapted to:
(i) create a partial vacuum within the output end enclosure;
(ii) draw away from within the output end enclosure low density materials for separation from the product stream.

17. A sorting conveyor for separating ferromagnetic materials from a stream of materials, said sorting conveyor comprising:
(a) a conveyor component having an input end and an output end;
(b) a conveyor drive system for driving the conveyor component to move the stream of materials from the input end to the output end for discharge of at least a portion of the stream of materials as a product stream at the output end;
(c) a magnetic separator that is:
(1) located adjacent the conveyor component;
(2) adapted to divert ferromagnetic materials from the stream of materials into a metal stream that is separate from the product stream;
(d) a controller that is operatively connected to the conveyor drive system and adapted to drive the conveyor drive system at a plurality of rates;
(e) a ferromagnetic material detector for detecting the presence of ferromagnetic materials in the stream of materials on the conveyor component, said ferromagnetic material detector being:
(1) located upstream of the magnetic separator;
(2) operatively connected to the controller and adapted to send a detection signal to the controller when ferromagnetic materials are detected in the stream of materials on the conveyor component;
(f) a timer that is operatively connected to the controller;
wherein the controller is programmed to drive the conveyor component at a predetermined first rate until the ferromagnetic material detector detects the presence of ferromagnetic materials in the stream of materials on the conveyor component, and to drive the conveyor component at a predetermined second rate that is slower than the first rate for a predetermined period of time after receipt of the detection signal from the ferromagnetic material detector.

18. The sorting conveyor of claim 17 wherein the controller is programmed to drive the conveyor component at the predetermined first rate after the expiration of the predetermined period of time.

19. A method for separating ferromagnetic materials from a stream of materials, said method comprising:
(a) providing a sorting conveyor comprising:
(1) a conveyor component having an input end and an output end;
(2) a drive system for driving the conveyor component to move the stream of materials from the input end to the output end for discharge of at least a portion of the stream of materials as a product stream at the output end;
(3) a magnetic separator that is located adjacent the conveyor component, and adapted to divert ferromagnetic materials from the stream of materials into a metal stream that is separate from the product stream;
(4) a ferromagnetic material detector for detecting the presence of ferromagnetic materials in the stream of materials on the conveyor component, said ferromagnetic material detector being located upstream of the magnetic separator and adapted to send a detection signal when it detects the presence of ferromagnetic materials in the stream of materials on the conveyor component;
(5) a timer;
(6) a controller that is operatively connected to the conveyor drive system, the ferromagnetic material detector and the timer, said controller being adapted to drive the conveyor component at a predetermined first rate that is within the range of 50-150 feet per minute until the ferromagnetic material detector sends a detection signal indicating the presence of ferromagnetic materials in the stream of materials on the conveyor component, and to drive the conveyor component at a predetermined second rate that is within the range of 10-40% of the predetermined first rate for a predetermined period of time that is within the range of 15-40 seconds after receipt of the detection signal from the ferromagnetic material detector;
(b) operating the controller to drive the conveyor component at the predetermined first rate until the ferromagnetic material detector sends a detection signal indicating the presence of ferromagnetic materials in the stream of materials on the conveyor component, and then operating the controller to drive the conveyor component at the predetermined second rate for the predetermined period of time.

20. The method of claim 19 which includes operating the controller to drive the conveyor component at the predetermined first rate after the expiration of the predetermined period of time during which the controller has driven the conveyor component at the predetermined second rate.
